(19) United States
(12) Patent Application Publication
(10) Pub. No.: US 2006/0218090 A1
(43) Pub. Date: Sep. 28, 2006

(54) Method and server for transmitting data

(75) Inventors: Karsten Luettge, Berlin (DE); Enne Mitjana, Brussels (BE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 11/341,599

(22) Filed: Jan. 30, 2006

(30) Foreign Application Priority Data
Jan. 28, 2005 (EP) 05090012.5

(51) Int. Cl. G06Q 40/00

(52) U.S. Cl. 705/40; 705/35

(57) ABSTRACT

A method transmits data relating to a payment operation from a mobile communication terminal (KEG) to a payment system (ZS1, ZS2) in a communication network (GPRS). A server (S) in the communication network uses a first communication protocol (OTA) to receive payment data which come from an application program (A) running on the communication terminal. The server recognizes the communication terminal and the application program (A). The server uses a second communication protocol to transmit the payment data to the payment system (ZS2). In addition, the server transmits terminal data identifying the communication terminal to the payment system, which informs the payment system about the payment debtor. The server also transmits program data identifying the application program to the payment system, which informs the payment system about the payment receiver.

### CROSS REFERENCE TO RELATED APPLICATIONS

This application is based on and hereby claims priority to European Application No. 05090012.5 filed on Jan. 28, 2005, the contents of which are hereby incorporated by reference.

### BACKGROUND OF THE INVENTION

The invention relates to a method and a server for transmitting data relating to a payment operation from a mobile communication terminal to a payment system in a communication network.

Modern telecommunications engineering is already used today to provide telecommunication subscribers with a large number of services, applications or work, whose use needs to be paid for. In the future, such services, applications or work will frequently also involve application programs which are installed in communication terminals (e.g. in mobile telephones) or loaded into communication terminals and run in these communication terminals.

### SUMMARY OF THE INVENTION

One possible object of the invention is specifying a method and a server which can be used to transmit data relating to a payment operation which come from an application program running on a mobile communication terminal from the communication terminal to a payment system.

The inventors propose a method for transmitting data relating to a payment operation from a mobile communication terminal to a payment system in a communication network, where the method involves a server in the communication network using a first communication protocol to receive payment data which come from an application program running on the communication terminal, the server recognizing the communication terminal, the server recognizing the application program, the server using a second communication protocol to transmit the payment data to the payment system, the server transmitting terminal data identifying the communication terminal to the payment system, which informs the payment system about the payment debtor, and the server transmitting program data identifying the application program to the payment system, which informs the payment system about the payment receiver.

A particular advantage in this context is that the payment data received by the server using a first communication protocol are transmitted to the payment system using a second communication protocol. The use of different protocols protects the payment system against inadmissible or unauthorized access by the communication terminal, which significantly increases the security of the payment system. Another advantage is that the server recognizes (identifies) the communication terminal and that data identifying the communication terminal (terminal data) are transmitted to the payment system. This informs the payment system about the payment debtor, since identifying the communication terminal also identifies its operator or user. The operator or user is responsible for the payments made using his communication terminal. In addition, the server advantageously recognizes (identifies) the application program, and data identifying the application program (program data) are transmitted to the payment system. This means that the payment system knows the payment receiver, because if the application program is known then it is possible to infer the type of programmed application and the provider or issuer of the application program; the provider or issuer of the application program is the payment receiver in this case. The application program is thus associated with the payment receiver.

Another advantage is that the payment system does not need to be designed specifically for receiving payment data directly from the application program running on the communication terminal. The payment system therefore also does not need to provide any mechanisms for identifying the communication terminal (and its user) and/or the application program sending the payment data and reliably checking the recognized identity (authentication). This makes it possible, in particular, to use the method also in telecommunication environments which were originally not designed to receive payment data which are sent by an application program running on a communication terminal and are transmitted via the “air interface” using electromagnetic radiowaves. In addition, it advantageously becomes possible to use new, further developed or previously unused methods, for example, for identifying the communication terminal and its user, and also for identifying the application program, quickly and easily without this requiring changes on the payment system.

The form of the method may be such that the first communication protocol used is a communication protocol which is provided for data transmission using electromagnetic radiowaves. This allows data transmission between the mobile communication terminal and a server installed at a fixed location in a communication network.

The method may proceed in a manner such that the second communication protocol used is a communication protocol which is provided for data transmission to the payment system in the communication network. This advantageously allows the use of communication protocols which are already known as such and which are used in communication networks normally for communicating with payment systems. In particular, it is not necessary to provide a new communication protocol on the payment system which allows wireless communication between the mobile communication terminal and the (normally fixed-location) payment system in the communication network.

The method may proceed in a manner such that before transmitting the payment data to the payment system the server checks whether it has received authorization data relating to the payment operation which come from the communication terminal (or from the user thereof), and if the authorization data are present then the payment data are transmitted to the payment system. By way of example, this prevents payment data from being transmitted to the payment system under the initiation of an erroneous application program when the user of the communication terminal does not want such transmission. Errors in the application program may also be caused by program viruses, for example.

In this context, the method may proceed in a manner such that the server sends a request message to the communication terminal asking the communication terminal to send the authorization data to the server. This means that when the authorization data are not present the communication terminal is prompted to send such authorization data to the server.

The method may also proceed in a manner such that if the data link between the communication terminal and the server is broken then the server restores this data link. This advantageously ensures that the method can be continued even if the data link is broken—as occasionally occurs in the case of mobile communication terminals. Another advantage is that the data link does not need to be restored by the payment system, which significantly relieves the load on the payment system.

The method may also proceed in a manner such that the server recognizes the communication terminal by virtue of the server reading data which describe the communication terminal from the payment data.

The method may also proceed in a manner such that the server recognizes the application program by virtue of the server reading data which describe the application program from the payment data. The two variant embodiments of the method which are mentioned above are particularly simple variants for recognizing (identifying) the communication terminal and the application program.

The method may proceed in a manner such that the server decompresses the payment data sent in compressed form. This allows effective use of the often limited data transmission capacity (transmission band width) in mobile communication terminals.

The method allows the payment data to be transmitted in packet-oriented form.

The aforementioned object is likewise achieved by a server for transmitting data relating to a payment operation from a mobile communication terminal to a payment system in a communication network, which uses a first communication protocol to receive payment data which come from an application program running on the communication terminal, recognizes the communication terminal, recognizes the application program, uses a second communication protocol to transmit the payment data to the payment system, transmits terminal data identifying the communication terminal to the payment system, which informs the payment system about the payment debtor, and transmits program data identifying the application program to the payment system, which informs the payment system about the payment receiver.

This server may be in a form such that before transmitting the payment data to the payment system it checks whether it has received authorization data relating to the payment operation which come from the communication terminal, and if the authorization data are present then it transmits the payment data to the payment system.

The server may be in a form such that it sends a request message to the communication terminal asking the communication terminal to send the authorization data to the server. If the data link between the communication terminal and the server is broken then the server can restore this data link.

The server may be in a form such that it recognizes the communication terminal by reading data which describe the communication terminal from the payment data.

The server may be implemented such that it recognizes the application program by reading data which describe the application program from the payment data.

The server may be in a form such that it decompresses the payment data sent in compressed form.

The server can transmit the payment data in packet-oriented form.

The server mentioned above has advantages corresponding to those which were mentioned previously in connection with the method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary embodiment of an arrangement with a mobile communication terminal, a server and two payment systems, and

FIG. 2 shows an exemplary embodiment of a message flow according to one embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

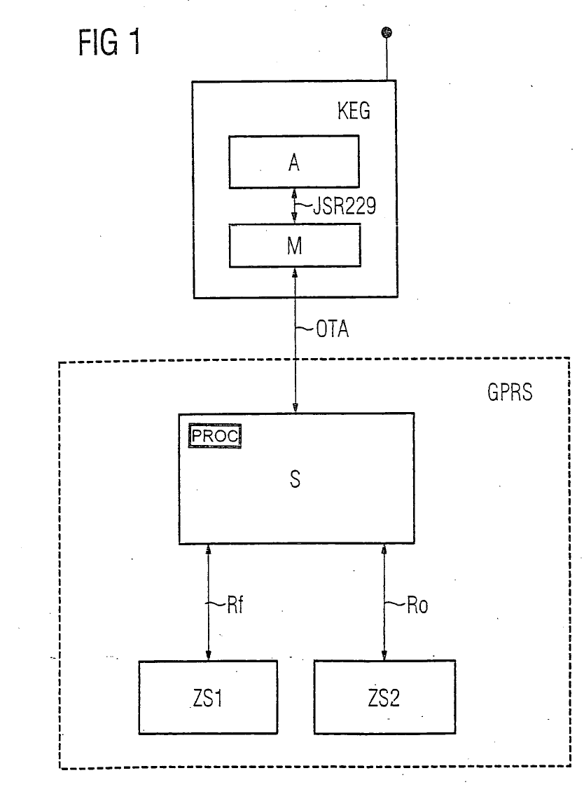

FIG. 1 shows a mobile communication terminal KEG which, by way of example, is a mobile telephone, a palmtop or a portable computer (laptop) with a mobile radiointerface. This mobile communication terminal KEG has an application program A installed in it. This application program A may be located in the main memory (RAM) or in a read only memory (e.g. Flash ROM), for example. The application program A uses a program interface (API=Application Programming Interface, e.g. uses the known interface JSR229) to communicate with a payment module M in the communication terminal. The payment module M in the communication terminal KEG uses a communication protocol (OTA communication protocol) provided for data transmission using electromagnetic radiowaves to communicate with a server S in a communication network GPRS. In this context, the abbreviation OTA stands for “Over The Air” and denotes a communication protocol which is used for data transmission, e.g. in mobile radio networks between the mobile terminals and the fixed-location devices in the mobile radio networks. Examples of an OTA protocol of this type which may be used are the following protocols: the WAP protocol (WAP=Wireless Application Protocol), the SOAP protocol (SOAP=simple object access protocol) or the SIP protocol (SIP=Session Initiation Protocol).

The server S in the communication network is implemented in the form of a proxy server, which is also called a “charging proxy”. The server S is operated, by way of example, by an operator of that communication network in which the payment system is situated. The server S is connected to a first payment system ZS1 via a known interface Rf. The first payment system ZS1 is a payment system in which incoming payment requests are registered and are billed at a later time (for example by producing a bill and sending it to the payment debtor). Payment systems of this kind as such are known and are also called “post-processing payment systems” or “offline charging systems”.

The server S is also connected to a second payment system ZS2 via a known interface Ro. This second payment system ZS2 bills incoming payment requests immediately by debiting the relevant payment sums from a prepaid account belonging to the payment debtor, for example. Such payment systems are also called “prepaid charging systems” or “online charging systems”. The interfaces Rf and Ro for communication with the first payment system ZS1 and with the second payment system ZS2, respectively, as such are known, by way of example, from the specification 3GPP TS 32.240; Technical Specification; 3rd Generation Partnership Project; Technical Specification Group Services and System Aspects; Telecommunication management; Charging management; Charging architecture and principles (Release 6).

The server S ensures that when the data sent by the mobile communication terminal are received the protocol functions provided by the OTA protocol (e.g. encryption, compression or resumption of communication following temporary loss of the link) are used. This has the advantage that the payment systems are not encumbered by the often complicated cycles in the implementation of data transmissions using such an OTA protocol. Rather, the payment system ZS2 receives the payment data sent by the mobile communication terminal using a second communication protocol via the usual interface Ro; the payment system ZS1 receives payment data via the usual interface Rf.

In the exemplary embodiment, the communication network indicated is a mobile radio network designed on the basis of GPRS specifications (GPRS=General Packet Radio Service). The method described and the server described may also be implemented in other communication networks, however, for example in mobile radio networks based on the GSM or the UMTS standard. In particular, it is possible to use communication networks in which the data are transmitted in packet-oriented form, such as the Internet.

For reasons of clarity, FIG. 1 has not shown the transmission and reception devices which are always present in mobile communication terminals and in the associated communication networks, for example.

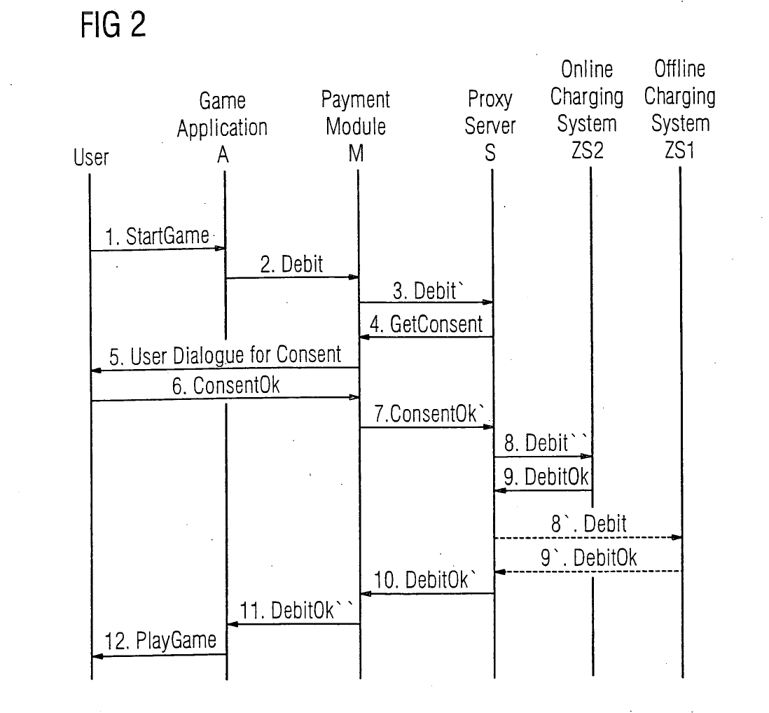

FIG. 2 shows an exemplary embodiment of a method cycle using the elements depicted in FIG. 1.

In this exemplary embodiment, it is assumed that a user of the communication terminal KEG has loaded an application program A in the form of a gaming program (game application) into his mobile communication terminal. The user may have obtained this gaming program from a games provider over the Internet, for example, by “download”, with the “download” possibly being free or subject to a cost. The user starts the gaming program locally in the memory in his communication terminal; the game runs locally on this communication terminal. Playing the game locally as such requires no interaction with other communication terminals or devices belonging to the games provider. It is the intention to bill for the use of the application program in the form of the gaming program on a use basis; in the exemplary embodiment, a payment sum will become due and will be billed whenever the game is used. This payment method is also called the “pay-per-play” method or the “pay-per-use” method.

When the gaming program A has been started on the communication terminal KEG (cf. arrow 1: StartGame) the application program A produces a payment request message and sends this payment request message via the program interface JSR229 to the payment module M (arrow 2: Debit). By way of example, this payment request message contains information about the sum which is to be payed (e.g. payment sum 1 euro), information about the operation underlying the payment (e.g. chess game, level 3), the current time (time stamp), a terminal data item identifying the communication terminal (e.g. the terminal identification IMEI=International Mobile Equipment Identity or user identification, e.g. in the form of the mobile radio telephone number MSIDN) and also program data identifying the application program (e.g. program name, program version and/or (optionally) program provider). These data or this information is/are transmitted from the application program A to the payment module (M) using the payment request message.

The payment module M receives the data from the application program A and generates a payment message therefrom (arrow 3: Debit). This payment message containing payment data is sent from the payment module M using a first communication protocol in the form of the OTA protocol via a transmission device (not shown) in the communication terminal KEG and a reception device (not shown) in the communication network GPRS to the server S in the communication network. To this end, the payment message is addressed using an IP address for the server, an SIP address for the server or a telephone number for the server (e.g. an E164 telephone number), for example. The payment message also contains the request to have the payment sum debited from a prepaid account belonging to the user (online charging).

Alternatively, the method described may also proceed in a manner such that the program data identifying the application program and/or the terminal data identifying the communication terminal are not transmitted from the application program A to the payment module M using the payment request message, but rather that the payment module M requests these data independently from the communication terminal or the application program and inserts them into the payment message (debit). Since the payment module M is installed in the mobile communication terminal (and is part of the operating system, for example, the payment module is classified as trustworthy, which means that the terminal data and program data ascertained by the payment module can be used to carry out the payment operation.

The server S uses the OTA protocol to receive the payment message Debit containing the payment data. The server S ensures that the communication carried out with the mobile communication terminal using the OTA communication protocol takes place in compliance with the protocol. Should the data link between the communication terminal and the server be interrupted, for example (which occasionally occurs in mobile communication terminals), then the server restores this data link. In addition, the server decompresses the payment data in the payment message Debit which have been sent in compressed form using the OTA protocol.

When the server S has received the payment message Debit containing the payment data using the OTA protocol, the server S has a processor PROC recognizes (identifies) the communication terminal. This is done by virtue of the server S reading the data described in the communication terminal KEG (for example the terminal identification data IMEI) from the payment data in the payment message Debit. In addition, the server S recognizes (identifies) the application program A by reading the data describing the application program (e.g. program name and program version) from the payment data in the payment message.

Optionally, the server S may additionally authenticate the communication terminal and/or the application program, i.e. may establish whether the terminal data or program data which are also sent with the payment message are correct. This may be done, by way of example, by virtue of the server checking digital signatures which have also been sent with the payment message.

Optionally, the server may use databases provided in the communication network (e.g. the HLR, Home Location Register), for example, to check whether the data transmitted with the payment message are consistent, that is to say whether, by way of example, the communication terminal with the terminal data IMEI is actually associated with the user with the mobile radio telephone number MSISDN and/or whether the application program A is registered as an application program which is authorized to send payment messages.

In the case of large payment sums or even generally, an additional protective measure provided may be that before the payment data are transmitted to the payment system the server checks whether it has received authorization data relating to the payment operation which come from the communication terminal KEG. Only if such authorization data are present are the payment data then transmitted to the payment system. If such authorization data are not present on the server S then the server S sends a request message (arrow 4: GetConsent) to the communication terminal KEG. This request message is used to ask the communication terminal to send the authorization data to the server. (In this case, with appropriate user configuration of the communication terminal, provision may be made for the communication terminal not to send the authorization data until after the user has explicitly released these authorization data for the payment operation, e.g. by a dialog using a display and a keypad on the communication terminal).

The server S sends the request message (arrow 4) to the payment module M. By way of example, the request message contains the requested payment sum and the event underlying the payment (“chests game, 1 euro”).

The payment module M now starts a dialog with the user of the communication terminal, for example by text outputs on the display of the communication terminal or by the output of a voice message via a built-in loudspeaker in the communication terminal (arrow 5: User Dialog for Consent). This user dialog is used to inform the user that the application program has initiated or started a payment operation. The user dialog is used to ask the user to document his consent to the payment operation and to the payment sum by pressing a key on the communication terminal, for example, or by expressing his consent with a voice response (“I accept”) (arrow 6: ConsentOk). If consent has been given, the payment module M sends authorization data about consent being received from the user in the form of an authorization message (arrow 7: ConsentOk′) to the server S using the OTA protocol. This means that the server S now has the authorization data relating to the payment operation.

(In another exemplary embodiment, the server S may also request the authorization data by virtue of the server S asking a voice unit (not shown in the figures) in the communication network (for example implemented by a unit IP=Intelligent Peripheral) to send a voice call to the communication terminal. In this case, the unit IP would register and evaluate the user's response and—if consent has been given—send the authorization data to the server S.

Other variants for the server S to obtain the authorization data are possible. A common feature of them is that the server checks whether such authorization data are already present, and if the authorization data are not present it initiates a dialog with the user of the communication terminal; the result of this dialog is that the authorization data are transmitted to the server.)

In the exemplary embodiment, the authorization data are now present on the server S. The server S then sends the payment data using a payment message (arrow 8: Debit) to the second payment system ZS2 using the interface Ro and using a (second) communication protocol, which is provided for data transmission to the payment system ZS2. A second communication protocol of this type which may be used is the communication protocol DIAMETER, known as such, or the communication protocol RADIUS, for example. The payment message (arrow 8) is used to instruct the payment system ZS2 to debit the payment sum from the user's prepaid account.

The payment message (arrow 8: Debit) is also used to transmit the terminal data identifying the communication terminal KEG and/or the program data identifying the application program to the payment system ZS2. From the terminal data, the payment system ascertains the payment debtor, for example by virtue of the payment system reading the name and the account number of the owner or user of the communication terminal from a database. This database stores an association between the terminal data (e.g. the IMEI number) and the name of the owner or user and his account. Using the program data identifying the application program (for example program name and program version), the payment system ascertains the payment receiver by virtue of the payment system reading the name of the payment receiver associated with this application program and also his account number from a database, for example. This database stores associations between application programs and the respective persons or institutions which make the application programs available to the users and in return receive payments when the application programs are used.

(If information about the program provider has already been transmitted with the program data, it is possible to dispense with reading the database in this regard.) The database also stores associations between the accounts of these persons or institutions and also information about the service, application or work which is to be provided using the application program. This means that the program data also inform the payment system about the service, application or work for which payment is required.

Using the received payment data, terminal data and/or program data, the second payment system ZS2 then debits the appropriate payment sum from the payment debtor's prepaid account and credits the payment sum (either immediately or later) to the payment receiver's account.

If debiting is successful (e.g. if the prepaid account has a sufficient account balance), the second payment system ZS2 returns an acknowledgement message (arrow 9: DebitOk) to the server S. The server S forwards the information about the successful debit to the payment module M using the OTA protocol by a further acknowledgement message (arrow 10: DebitOk′). The payment module M then forwards the information about the successful debit to the application program A using the program interface JSR229 (arrow 11: DebitOK″). This notifies the application program A that the payment operation has been performed successfully. (Optionally, the payment module M may additionally also notify the user that the payment operation has been concluded successfully.) The application program then allows the user to use the program; in the exemplary embodiment, the user can play the computer game. The use may be restricted, for example to a period which is dependent on the payment sum or to a prescribed number of program events (for example a number of rounds of chess) for which the payment sum suffices.

In an alternative exemplary embodiment, the user's consent may also be gotten (“GetConsent”) by the payment module M, by virtue of this payment module M using a JSR229 method, for example. In this alternative exemplary embodiment, the payment module M would not send the payment message (arrow 3: Debit) to the server S until the authorization data are present on the payment module.

In another exemplary embodiment, the payment operation can also be performed using the first payment system ZS1 (offline charging system), as shown in FIG. 2 by the dashed arrows 8′ and 9′. In this case, the server S does not send the payment message (arrow 8: Debit) but rather a payment message (arrow 8′: Debit) to the first payment system ZS1. The first payment system ZS1 writes the payment data to a database or to a charge data record, for example in order to put the appropriate payment sum onto a bill relating to the payment debtor when the next bill is produced. The first payment system ZS1 then returns an appropriate acknowledgement message (arrow 9′: DebitOk) to the server S. In this exemplary embodiment, the payment message (arrow 3) would contain the request to record the payment sum in a charge data record for inclusion in the next possible monthly bill, for example.

A method has been described for transmitting data relating to a payment operation from a mobile communication terminal to a payment system in a communication network in which a server (Proxy Server) is arranged at a fixed location in a communication network (e.g. a mobile radio network). This server collects the payment data which come from the mobile communication terminal. These payment data which are sent by the mobile communication terminal using an OTA protocol by “charging requests” are forwarded by the server using a communication protocol which is used in the communication network to communicate with a payment system installed therein. An example of such a protocol is the DIAMETER protocol. In addition, the server S uses the OTA protocol to communicate with the mobile communication terminal and also optionally to identify and/or authenticate the communication terminal and/or the application program.

A fundamental task of the payment module M in the mobile communication terminal KEG is that this module forwards the data received from the application program A to the server S using a payment message (charging message).

The server S relieves the load on the payment systems ZS1 and ZS2 because the server S identifies and/or authenticates the communication terminal and the application program and ensures that the user's consent is gotten. The payment systems are thus unencumbered by these functions.

A particular advantage of the method described and of the server described is that the server S converts the payment messages coming from a mobile communication terminal such that they are compatible with the usual standard interfaces of the payment systems in the communication network. This means that the payment systems which are usual in communication networks (and which are provided therein for the purpose of billing for the normal telephone charges, for example) can also be used to handle such “terminal initiated charging requests” and to perform relevant payment operations. By way of example, payment requests or payment messages initiated by a mobile telephone can result in a payment operation in which the relevant payment sum is entered on the normal telephone bill for a communication terminal user. In the case of the method described, another advantage is that just one server S needs to be installed in the communication network, which is possible with little cost involvement. In particular, it is not necessary to make modifications to the payment systems or to the interfaces in the payment systems. By way of example, this allows the network operator to use the already existing payment systems and the already existing interfaces in the payment systems also for charging for events which are initiated by a mobile communication terminal. Examples of such events are leaving software programs running locally in a memory in a mobile communication terminal or particular control actions by a user of the communication terminal which concern the locally running application program. This makes it possible to bill for or charge for such “terminal initiated charging events” in a particularly simple and inexpensive manner.

In the exemplary embodiment, the application program described was a gaming program. In other exemplary embodiments, alternatively a large number of other programs running in a mobile communication terminal may be used as an application program of this type, e.g. an MP3 player program.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method for transmitting data relating to a payment operation from a mobile communication terminal to a payment system in a communication network, the method comprising:
using a first communication protocol to receive payment data at a server in the communication network from an application program running on the communication terminal;
recognizing the communication terminal at the server;
recognizing the application program at the server;
using a second communication protocol to transmit the payment data from the server to the payment system;
transmitting terminal data identifying the communication terminal from the server to the payment system, the terminal data informing the payment system about a payment debtor; and
transmitting program data identifying the application program from the server to the payment system, the program data informing the payment system about a payment receiver.

2. The method as claimed in claim 1, wherein the first communication protocol is a communication protocol for data transmission using electromagnetic radio waves.

3. The method as claimed in claim 1, wherein the second communication protocol is a communication protocol which is provided for data transmission to the payment system in the communication network.

4. The method as claimed in claim 1, wherein
before transmitting the payment data to the payment system, the server checks whether the server has received authorization data from the communication terminal relating to the payment operation, and
if the authorization data are present, then the payment data are transmitted to the payment system.

5. The method as claimed in claim 4, wherein
the server sends a request message to the communication terminal asking the communication terminal to send the authorization data to the server.

6. The method as claimed in claim 1, wherein
the server communicates with the communication terminal via a data link between the communication terminal and the server,
if the data link between the communication terminal and the server is broken, then the server restores the data link.

7. The method as claimed in claim 1, wherein the server recognizes the communication terminal by reading information from the payment data, which describes the communication terminal.

8. The method as claimed in claim 1, wherein the server recognizes the application program by reading information from the payment data, which describes the application program.

9. The method as claimed in claim 1, wherein
the payment data is sent in compressed form, and
the server decompresses the payment data sent in compressed form.

10. The method as claimed in claim 1, wherein the payment data is transmitted in a packet-oriented form.

11. A server for transmitting data relating to a payment operation from a mobile communication terminal to a payment system in a communication network, comprising:
a data link to the communication terminal, operating on a first communication protocol to receive payment data from an application program running on the communication terminal;
a processor to recognize the communication terminal and the application program; and
a communication interface using a second communication protocol to transmit:
the payment data to the payment system,
terminal data identifying the communication terminal to the payment system, the terminal data informing the payment system about a payment debtor, and
program data identifying the application program to the payment system, the program data informing the payment system about a payment receiver.

12. The server as claimed in claim 11, wherein
before transmitting the payment data to the payment system, the server checks whether the server has received authorization data from the communication terminal relating to the payment operation, and
if the authorization data are present, then the payment data are transmitted to the payment system.

13. The server as claimed in claim 11, wherein
the server sends a request message to the communication terminal asking the communication terminal to send the authorization data to the server.

14. The server as claimed in claim 11, wherein if the data link between the communication terminal and the server is broken, then the server restores the data link.

15. The server as claimed in claim 11, wherein the server recognizes the communication terminal by reading information from the payment data, which describes the communication terminal.

16. The server as claimed in claim 11, wherein the server recognizes the application program by reading information from the payment data, which describes the application program.

17. The server as claimed in claim 11, wherein
the payment data is sent in compressed form, and
the server decompresses the payment data sent in compressed form.

18. The server as claimed in claim 11, wherein the payment data is transmitted in a packet-oriented form.

19. The server as claimed in claim 12, wherein
the server sends a request message to the communication terminal asking the communication terminal to send the authorization data to the server.

20. The server as claimed in claim 19, wherein if the data link between the communication terminal and the server is broken, then the server restores the data link.
